(19) United States
(12) Patent Application Publication
(10) Pub. No.: US 2018/0200816 A1
(43) Pub. Date: Jul. 19, 2018

(54) WIRE CUTTING PRECISION JIG

(71) Applicant: CITIC Dicastal CO.,LTD., Qinhuangdao (CN)

(72) Inventors: Weidong Liu, Qinhuangdao (CN); Yukun Yang, Qinhuangdao (CN); Zhi Chang, Qinhuangdao (CN); Guidong Yang, Qinhuangdao (CN); Yu Chang, Qinhuangdao (CN); Yongwang Zhao, Qinhuangdao (CN)

(21) Appl. No.: 15/620,102

(22) Filed: Jun. 12, 2017

(30) Foreign Application Priority Data
Jan. 18, 2017 (CN) 201710036036.9

(51) Int. Cl. B23H 11/00; G01N 3/08

(52) U.S. Cl. CPC B23H 11/003; G01N 3/08

(57) ABSTRACT

Disclosed is a wire cutting precision clamp, comprising a base, a gear, a bearing, a rotating shaft, a sliding block, a gland and the like, wherein the rotating shaft is installed on the base) via the bearing and the gland, the gear is installed on the rotating shaft, and the sliding block is closed on the base by the end cover. Symmetrical T-shaped chutes are provided on two inner sides of the base, symmetrical T-shaped columns are provided on the lower end face of the sliding block, and the T-shaped columns of the sliding block are capable of being inserted into the T-shaped chutes of the base. A rack is arranged in the middle of the lower end face of the sliding block, and the rack is engaged with the lead screw gear.

### CROSS-REFERENCE TO RELATED APPLICATIONS

This application is filed based upon and claims priority to Chinese Patent Application No. 201710036036.9, filed on Jan. 18, 2017, the entire contents of which are incorporated herein by reference.

### TECHNICAL FIELD

The disclosure relates to a jig, and specifically to a wire cutting precision jig for machining a tensile sample.

### BACKGROUND

In the production process of an automobile wheel, various mechanical properties of each part of the wheel need to be detected to ensure the safety of the wheel. In order to detect the tensile stresses of different positions of the same part of a rim, the outer rim needs to be cut into a plurality of samples for tensile test. However, the outer rim of the wheel is of a combined structure of multiple groups of curved surfaces, and simultaneously, the rim is relatively thin, so the positioning manner of the samples is an important factor influencing the cutting effect.

### SUMMARY

The disclosure is aimed at providing a wire cutting precision jig.

In order to fulfill the aim, the disclosure adopts the technical solution: a wire cutting precision jig, which is composed of a base, a gear, a bearing, a rotating shaft, a sliding block, a gland, a lock screw and an end cover. The rotating shaft is installed on the base via the bearing and the gland, the gear is installed on the rotating shaft, and the sliding block is closed on the base by the end cover.

Symmetrical T-shaped chutes are provided on two inner sides of the base, symmetrical T-shaped columns are provided on the lower end face of the sliding block, and the T-shaped columns of the sliding block are capable of being inserted into the T-shaped chutes of the base in clearance fit.

A rack is arranged in the middle of the lower end face of the sliding block, and the rack is engaged with the lead screw gear. The rotating shaft drives the gear to rotate, and the sliding block can stably move left and right along the T-shaped chutes in the base under engaging fit of the ring rack and the gear.

In practical use, the base is installed on wire cutting equipment, the rotating shaft is rotated, the sliding block moves right along the T-shaped chutes in the base under the engaging fit of the ring rack and the gear, the right end face of the sliding block finally extrudes a sample onto the base, and then the sliding block is locked via the lock screw. So far, the clamping operation of the sample is completed, and the wire cutting equipment starts machining the sample.

The wire cutting precision jig of the present disclosure in use can meet the requirement of wire cutting clamping, and has the characteristics of ideal effect, high efficiency, working safety and reliability, etc.

### BRIEF DESCRIPTION OF THE DRAWINGS

FIG. 1 is a schematic side view of a wire cutting precision jig of the present disclosure.

FIG. 2 is a schematic front view of the wire cutting precision jig of the present disclosure.

FIG. 3 is a schematic top view of the wire cutting precision jig of the present disclosure.

FIG. 4 is a structural schematic diagram of a base in the wire cutting precision jig of the present disclosure.

FIG. 5 is a schematic cross sectional view along A-A of the base in the wire cutting precision jig of the present disclosure.

FIG. 6 is a structural schematic diagram of a sliding block in the wire cutting precision jig of the present disclosure.

FIG. 7 is a schematic cross sectional view along A-A of the sliding block in the wire cutting precision jig of the present disclosure.

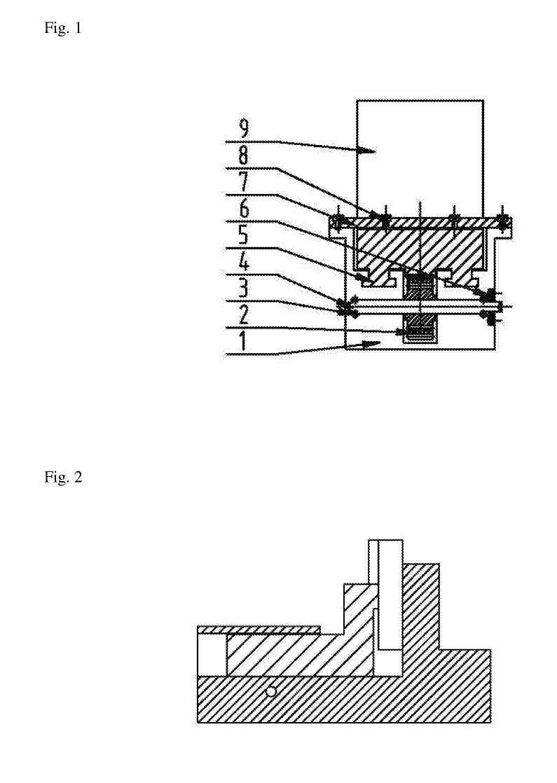

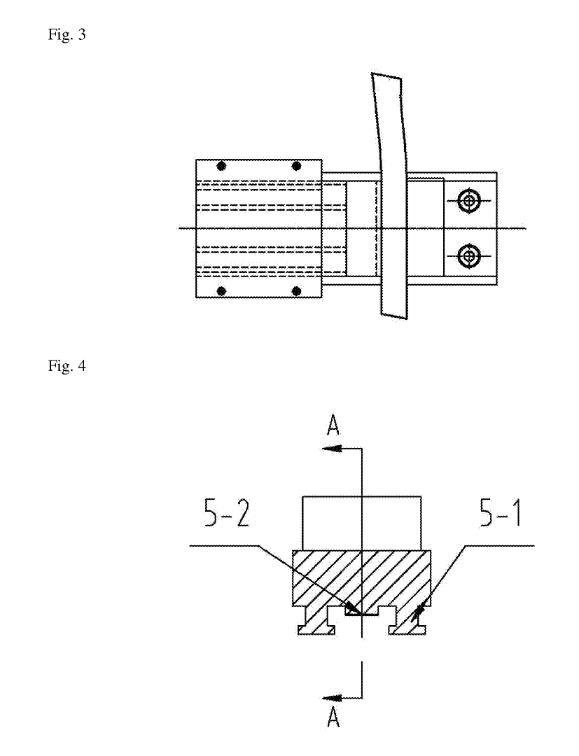

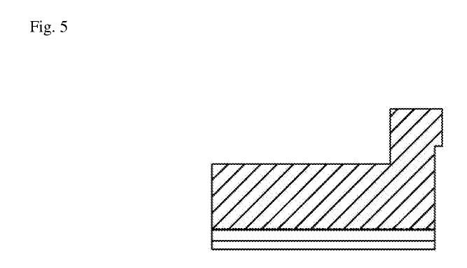

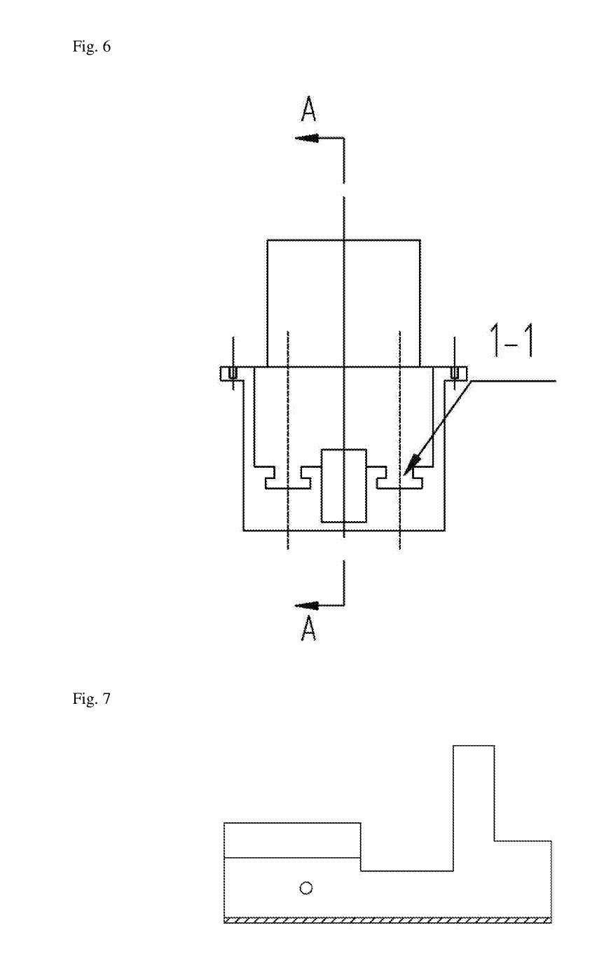

### LIST OF REFERENCE SYMBOLS

1 base
2 gear
3 bearing
4 rotating shaft
5 sliding block
6 gland
7 lock screw
8 end cover
9 sample

### DETAILED DESCRIPTION

Details and working conditions of a specific device provided by the present disclosure will be described in detail below in combination with the accompanying drawings.

A wire cutting precision jig is composed of a base 1, a gear 2, a bearing 3, a rotating shaft 4, a sliding block 5, a gland 6, a lock screw 7 and an end cover 8. The rotating shaft 4 is installed on the base 1 via the bearing 3 and the gland 6, the gear 2 is installed on the rotating shaft 4, and the sliding block 5 is closed on the base 1 by the end cover 8.

Symmetrical T-shaped chutes 1-1 are provided on two inner sides of the base 1, symmetrical T-shaped columns 5-1 are provided on the lower end face of the sliding block 5, and the T-shaped columns 5-1 of the sliding block 5 are capable of being inserted into the T-shaped chutes 1-1 of the base 1 in clearance fit.

A rack 5-2 is arranged in the middle of the lower end face of the sliding block 5, and the rack 5-2 is engaged with the lead screw gear 2. The rotating shaft 4 drives the gear 2 to rotate, and the sliding block 5 can stably move left and right along the T-shaped chutes 1-1 in the base 1 under engaging fit of the ring rack 5-2 and the gear 2.

In practical use, the base 1 is installed on wire cutting equipment, the rotating shaft 4 is rotated by a tool, the sliding block 5 moves right along the T-shaped chutes 1-1 in the base 1 under the engaging fit of the ring rack 5-2 and the gear 2, the right end face of the sliding block 5 finally extrudes a sample 9 onto the base 1, and then the sliding block 5 is locked via the lock screw 7. So far, the clamping operation of the sample 9 is completed, and the wire cutting equipment starts machining the sample.

What is claimed is:

1. A wire cutting precision jig, being composed of a base, a gear, a bearing, a rotating shaft, a sliding block, a gland, a lock screw and an end cover, wherein the rotating shaft is installed on the base via the bearing and the gland, the gear is installed on the rotating shaft, the sliding block is closed on the base by the end cover, symmetrical T-shaped chutes are provided on two inner sides of the base, symmetrical T-shaped columns are provided on a lower end face of the sliding block, and the T-shaped columns of the sliding block are capable of being inserted into the T-shaped chutes of the base.

2. The wire cutting precision jig of claim 1, wherein a rack is arranged in the middle of the lower end face of the sliding block, the rack is engaged with the lead screw gear, the rotating shaft drives the gear to rotate, and the sliding block moves left and right along the T-shaped chutes in the base.
